(19) United States
(12) Patent Application Publication
(10) Pub. No.: US 2008/0309910 A1
(43) Pub. Date: Dec. 18, 2008

(54) Vibration isolating apparatus, control method for vibration isolating apparatus, and exposure apparatus

(75) Inventor: Masato Takahashi, Hiki-gun (JP)

Correspondence Address: OLIFF & BERRIDGE, PLC, P.O. BOX 320850, ALEXANDRIA, VA, 22320-4850, US

(73) Assignee: NIKON CORPORATION, Tokyo (JP)

(21) Appl. No.: 12/155,077

(22) Filed: May 29, 2008

Related U.S. Application Data
(60) Provisional application No. 60/924,992, filed on Jun. 7, 2007.

(30) Foreign Application Priority Data
May 31, 2007 (JP) 2007-144864

(51) Int. Cl. G03B 27/58; F16M 9/00

(52) U.S. Cl. 355/72; 248/638

(57) ABSTRACT

An active vibration isolating apparatus can perform vibration isolation with high precision and fast response speed using a gas damper. A vibration isolating apparatus comprises an air damper that uses air supplied from a compressed air source to support a structure on an installation surface; a servo valve that controls the flow rate of the air that is supplied from the compressed air source to the air damper; a position sensor that measures a position provided to the structure by the air damper; and a vibration isolating block control system that controls the flow rate of the air at the servo valve based on the measurement value of the position sensor.

### CROSS-REFERENCE TO RELATED APPLICATION

This application is a non-provisional application claiming priority to and the benefit of U.S. provisional application No. 60/924,992, filed Jun. 7, 2007. Furthermore, this application claims priority to Japanese Patent Application No. 2007-144864, filed May 31, 2007. The entire contents of which are incorporated herein by reference.

### BACKGROUND

1. Field of the Invention

The present invention relates to vibration isolating technology that uses a gas damper to support a structure so that vibrations are suppressed, and to exposure technology and device fabrication technology that use this vibration isolating technology.

2. Related Art

Lithography, which is one of the processes used to fabricate devices (microdevices and electronic devices) such as semiconductor devices and liquid crystal displays, uses an exposure apparatus, e.g., a full-field exposure type (stationary exposure type) projection exposure apparatus (stepper) or a scanning exposure type projection exposure apparatus (scanning stepper), to expose a wafer (or a glass plate and the like), which is coated with a photoresist, by transferring a pattern, which is formed in a reticle (or a photomask and the like), onto the wafer. Conventionally, vibration isolating blocks are disposed in the exposure apparatus between an installation surface (a floor, a column, or the like) and, for example, the stages to eliminate the effects of vibrations and improve positioning accuracy of the reticle and wafer stages as well as exposure accuracy, e.g., overlay accuracy.

A mechanism that uses an air damper (which is supplied with air in an open loop to maintain its interior pressure so that it is substantially constant) to support the stage and the like, and an active vibration isolating apparatus that combines the air damper with an actuator to suppress vibrations detected by a motion sensor (e.g., an acceleration sensor) disposed on the stage and the like, are used as the conventional vibration isolating block. Furthermore, an active vibration isolating apparatus has been proposed (e.g., refer to Japanese Patent Application Publication No. 2002-175122 A) that controls the pressure, which is measured by a pressure sensor, inside the air damper in a closed loop so that it reaches a target pressure, which is obtained by using the detection result of the motion sensor.

With a conventional active vibration isolating apparatus that controls the pressure of a air damper in a closed loop, there are problems in that the resolving power of the pressure sensor, which is a diaphragm type or the like, that measures the pressure inside the air damper is low and the response speed is slow; therefore, it is difficult to isolate the stage and the like from vibrations with high precision and with fast response speed (tracking speed). Consequently, with an application that requires high precision vibration isolation at a fast response speed, such as with an exposure apparatus, there is a need to combine an actuator that has a fast response speed with the air damper.

A purpose of some aspects of the invention is to provide active vibration isolating technology that can perform vibration isolation with high precision and fast response speed using a gas damper such as an air damper, or to provide active vibration isolating technology that can obtain the internal pressure of the gas damper with high precision and fast response speed.

Another purpose is to provide exposure technology and device fabrication technology that use that active vibration isolating technology.

### SUMMARY

A first aspect of the invention provides a vibration isolating apparatus according to the present invention has a gas supply source, which supplies gas, and a gas damper, the interior of which is supplied with the gas, that supports a structure on an installation surface, and comprises: a flow control apparatus that controls the flow rate of the gas that is supplied from the gas supply source, and supplies the gas to the gas damper; a state quantity sensor that monitors a state quantity related to thrust that is applied to the structure from the gas damper; and a control apparatus that controls the flow rate of the gas at the flow control apparatus based on the state quantity that is measured by the state quantity sensor.

A second aspect of the invention provides an exposure apparatus that comprises a vibration isolating apparatus according to the above-described aspect to support prescribed members that constitute the exposure apparatus on a base member.

A third aspect of the invention provides a device fabricating method, wherein the exposure apparatus according to the above-described aspect is used.

A fourth aspect of the invention provides a control method for a vibration isolating apparatus that comprises a gas supply source and a gas damper, the interior of which is supplied with gas form the gas supply source, that supports a structure on an installation surface, the method comprising: measuring a value related to a derivative component of an internal pressure of the gas damper; and electrically integrating the value obtained by the measurement to obtain a value of the internal pressure.

According to the equation of state of the gas inside the gas damper, the flow rate of the gas is substantially proportional to the derivative of the pressure, and the integral of the flow rate is substantially the pressure. In an aspect of the invention, controlling the flow rate of the gas to the gas damper makes it possible to perform vibration isolation with faster response speed and higher precision than the case wherein the pressure in the gas damper is controlled based on, for example, the measurement values of the pressure inside the gas damper.

Furthermore, in an aspect of the invention, by measuring the value related to the derivative component of the internal pressure of the gas damper, the internal pressure can be obtained with faster response speed and higher precision.

### BRIEF DESCRIPTION OF THE DRAWINGS

FIG. 1 shows a schematic configuration of an exposure apparatus according to a first embodiment.

FIG. 2 is a partial cutaway view that shows the state wherein the exposure apparatus of FIG. 1 is installed on a floor.

FIG. 3 shows one of the vibration isolating blocks in FIG. 2 and its control system.

FIG. 4 shows a dynamic model of the vibration isolating block of FIG. 3.

FIG. 5 is a block diagram that shows the configuration of a vibration isolating block control system according to the first embodiment.

FIG. 6A shows the state wherein a servo valve of FIG. 3 feeds compressed air to an air damper using a spool valve system.

FIG. 6B shows the state wherein the servo valve exhausts the air from the air damper.

FIG. 7 shows one example of the frequency characteristics for the case wherein a structure that is supported by the vibration isolating block in FIG. 3 vibrates.

FIG. 8 is a block diagram that shows the configuration of the vibration isolating block control system according to a second embodiment.

FIG. 9 shows a block diagram that shows a modified example of the second embodiment.

FIG. 10 is a flow chart diagram that shows one example of a process of fabricating a microdevice.

### DESCRIPTION OF EMBODIMENTS

### FIRST EMBODIMENT

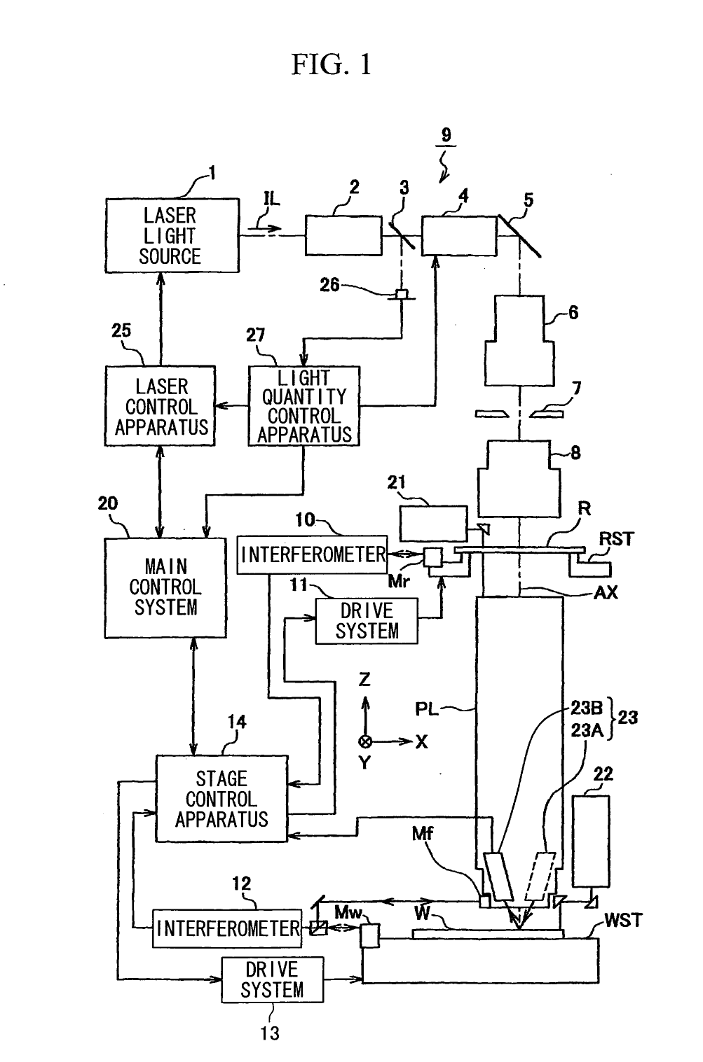

A first embodiment, which is the preferred embodiment of the present invention, will now be explained, referencing FIG. 1 through FIG. 7. In the present embodiment, the present invention is adapted to the case wherein vibration isolation is performed for a scanning exposure type exposure apparatus (a scanning type exposure apparatus) that comprises a scanning stepper (a scanner).

FIG. 1 is a block diagram of the functional units that constitute the exposure apparatus (projection exposure apparatus) of the present embodiment; in FIG. 1, the chamber that houses the exposure apparatus is omitted. In FIG. 1, a laser light source 1, which comprises an ArF excimer laser (193 nm wavelength), is used as an exposure light source. An ultraviolet pulsed laser light source such as a KrF excimer laser (248 nm wavelength) or an F₂ laser (157 nm wavelength), a harmonic generating light source such as a YAG laser, a harmonic generation apparatus such as a solid state laser (e.g., a semiconductor laser), or a mercury lamp (e.g., i-line) can also be used as the exposure light source.

Illumination light (exposure light) IL from the laser light source 1 is radiated to a reticle blind mechanism 7 with a uniform luminous flux intensity distribution via a uniformizing optical system 2 (which comprises a lens system and an optical integrator), a beam splitter 3, a variable dimmer 4 that adjusts the amount of light, a mirror 5, and a relay lens system 6. The illumination light IL, which is limited to a slit shape or a rectangular shape by the reticle blind mechanism 7, is radiated to the reticle R through an image forming lens system 8, and an image of the opening of the reticle blind mechanism 7 is thereby formed on the reticle R. An illumination optical system 9 comprises the uniformizing optical system 2, the beam splitter 3, the variable dimmer 4, the mirror 5, the relay lens system 6, the reticle blind 7, and the image forming lens system 8.

An image of the portion of the circuit pattern area, which is formed in the reticle R (the mask), that is irradiated by the illumination light is formed and projected onto a wafer W (a substrate), which is coated with photoresist, through a projection optical system PL, which is telecentric on both sides and has a projection magnification β that is a reduction magnification (e.g., ¼). In one example, the visual field diameter of the projection optical system PL is approximately 27-30 mm. In the explanation below, the Z axis is parallel to an optical axis AX of the projection optical system PL, the X axis is set to the directions that are parallel to the paper surface of FIG. 1 within a plane that is perpendicular to the Z axis, and the Y axis is set to the directions that are perpendicular to the paper surface in FIG. 1. In the present embodiment, the directions along the Y axis (the Y directions) are the scanning directions of the reticle R and the wafer W during scanning exposure, and the illumination area of the reticle R is shaped so that it is long and narrow and extends in the directions along the X axis (the X directions), which are the non-scanning directions.

First, the reticle R, which is disposed on the object plane side of the projection optical system PL, is held by a reticle stage RST that moves during the scanning exposure at a constant speed at least in one of the Y directions on a reticle base (not shown) with an air bearing interposed between the reticle base and the reticle stage RST. The moving coordinates (the positions in the X directions and the Y directions as well as the rotational angle around the Z axis) of the reticle stage RST are successively measured by a movable mirror Mr, which is fixed to the reticle stage RST, and a laser interferometer system 10, which is disposed so that it opposes the movable mirror Mr; in addition, a drive system 11, which comprises linear motors, fine movement actuators, and the like, moves the reticle stage RST. Furthermore, the movable mirror Mr and the laser interferometer system 10 actually constitute a three-axis laser interferometer, with at least one axis in the X directions and two in the Y directions. The measurement information from the reticle laser interferometer system 10 is supplied to a stage control apparatus 14 that controls the operation of the drive system 11 based on that measurement information and on control information (input information) from a main control system 20, which comprises a computer that performs supervisory control of the operation of the entire apparatus.

Moreover, a wafer holder (not shown) holds the wafer W, which is disposed on the image plane side of the projection optical system PL, on a wafer stage WST, which is installed on a wafer base (not shown) with an air bearing interposed therebetween so that it can move during the scanning exposure at a constant speed at least in one of the Y directions and so that it can be stepped in the X directions and the Y directions. In addition, the moving coordinates of the wafer stage WST (the positions in the X directions and the Y directions as well as the rotational angle around the Z axis) are successively measured by a fiducial mirror Mf, which is fixed to a lower part of the projection optical system PL, a movable mirror Mw, which is fixed to the wafer stage WST, and a laser interferometer system 12, which is disposed so that it opposes the movable mirror Mw; in addition, a drive system 13, which comprises linear motors and actuators such as voice coil motors (VCMs), moves the wafer stage WST. Furthermore, the movable mirror Mw and the laser interferometer system 12 actually constitute a three-axis laser interferometer, with at least one axis in the X directions and two in the Y directions. The measurement information from the laser interferometer system 12 is supplied to the stage control apparatus 14, which controls the operation of the drive system 13 based on that measurement information and control information (input information) from the main control system 20.

In addition, the wafer stage WST also comprises a Z leveling mechanism, which controls the position in the Z directions (the focus position) as well as the inclination angles of the wafer W around the X and Y axes. An oblique incidence type, multipoint auto focus sensor 23 is disposed on the side surfaces of the lower part of the projection optical system PL, comprises a light projecting optical system 23A, which projects a slit image to a plurality of measurement points on the front surface of the wafer W, and a light receiving optical system 23B, which receives the light reflected by that front surface, and measures the amount of defocus at each of those measurement points. Based on the measurement information of the auto focus sensor 23, the stage control apparatus 14 drives the Z leveling mechanism of the wafer stage WST using an autofocus method so that the amount of defocus and the amount of deviation of the inclination angle of the wafer W fall within a prescribed control accuracy range during the scanning exposure.

Furthermore, if the laser light source 1 is an excimer laser light source, then a laser control apparatus 25, which is under the control of the main control system 20, is provided that controls the pulse oscillation mode (one-pulse mode, burst mode, standby mode, etc.) of the laser light source 1 and adjusts the average amount of pulsed laser light that is radiated. In addition, based on a signal from a photoelectric detector 26 (an integrator sensor) that receives part of the illumination light that is split by the beam splitter 3, a light quantity control apparatus 27 controls the variable dimmer 4 so that the proper amount of exposure is obtained, and transmits pulsed illumination light intensity (light quantity) information to the laser control apparatus 25 and the main control system 20.

Furthermore, in FIG. 1, in the state wherein the radiation of the illumination light IL to the reticle R has started, and an image of part of the pattern on the reticle R is projected through the projection optical system PL to a shot region on the wafer W, a scanning exposure operation is performed that synchronously moves (synchronously scans) the reticle stage RST and the wafer stage WST in the Y directions using the projection magnification β of the projection optical system PL as a speed ratio; thereby, the image of the pattern of the reticle R is transferred to that shot region. Subsequently, the irradiation of the illumination light IL is stopped; in this manner, the image of the pattern of the reticle R is transferred to each shot region of a plurality of shot regions on the wafer W using the step-and-scan method wherein the operation that steps the wafer W in the X and Y directions via the wafer stage WST and the abovementioned scanning exposure operation are performed repetitively.

When an exposure is to be performed, the reticle R and the wafer W must be aligned beforehand. Accordingly, the exposure apparatus in FIG. 1 is provided with a reticle alignment (RA) system 21, which sets the reticle R at a prescribed position, and an off-axis type alignment system 22, which detects marks on the wafer W.

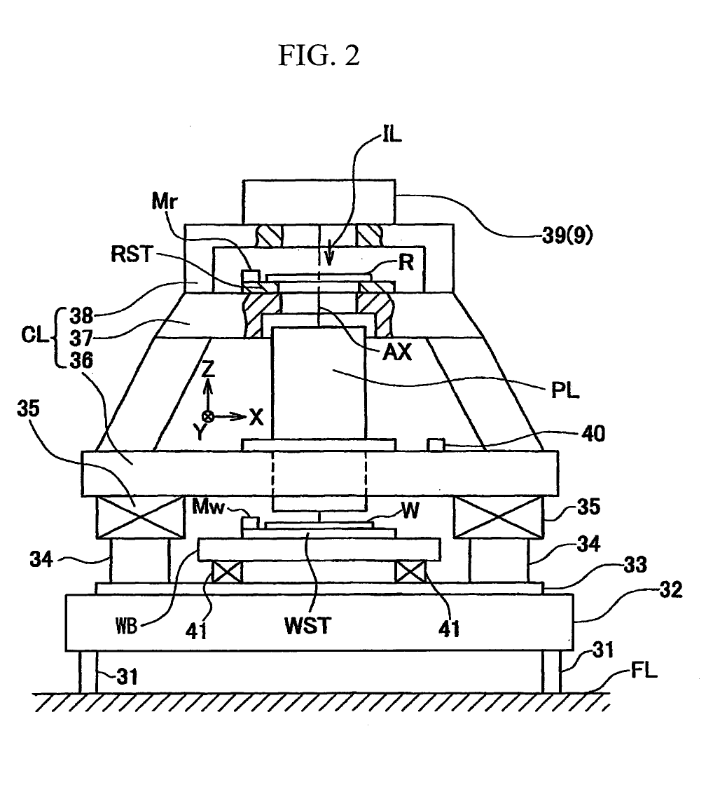

The following explains one example of the installation state of the exposure apparatus of the present embodiment in, for example, a semiconductor device fabrication plant. FIG. 2 shows one example of the exposure apparatus installation state; in FIG. 2, a thick, flat plate shaped pedestal 32, which serves as a foundation member when the exposure apparatus is installed, is installed on a floor FL of the fabrication plant with multiple (for example, four or more) support posts 31, which are made of H-beam steel or the like, interposed therebetween, and a rectangular, thin plate shaped base plate 33, which is for installing the exposure apparatus, is fixed on the pedestal 32.

A first column 36 is mounted on the base plate 33 with three or four support members 34 and active vibration isolating blocks 35 (the mechanisms of the vibration isolating apparatuses) interposed therebetween, and the projection optical system PL is held in an opening at the center of the first column 36. The vibration isolating blocks 35 include air dampers as discussed below; in addition, the first column 36 and members supported thereby can be actively isolated from vibrations by controlling the pressure (the internal pressure, i.e., the thrust produced by the air dampers) of the air inside each air damper based on the detection information from, for example, one set of acceleration sensors 40 and one set of position sensors (not shown) that are provided to the first column 36.

Examples of sensors that can be used as the acceleration sensors 40 include piezoelectric acceleration sensors, which detect the voltage generated by a piezoelectric device or the like, and semiconductor acceleration sensors, which take advantage of the fact that the logic threshold voltage of a CMOS converter varies with the magnitude of strain. Examples of sensors that can be used as the position sensors (or the displacement sensors) include eddy current displacement sensors. Eddy current displacement sensors take advantage of the fact that, if, for example, an alternating current is applied to a coil that is wound around an insulator, and that coil approaches a measurement target that is a conductor, then an eddy current is generated in the conductor because of the AC magnetic field that is produced by that coil, and the magnetic field generated by that eddy current affects the strength and phase of the electric current in the coil in accordance with its distance to the measurement target. Examples of other sensors that can also be used as the position sensors include electrostatic capacitance type, noncontactual displacement sensors, which detect distance noncontactually by taking advantage of the fact that electrostatic capacitance is inversely proportional to the distance between an electrode of the sensor and the measurement target, as well as optical sensors, which use a PSD (a semiconductor type position detecting apparatus) to detect the position of a light beam from a measurement target.

In addition, a reticle base 37 is fixed to an upper part of the first column 36, a second column 38 is fixed so that it covers the reticle base 37, and an illumination optical subchamber 39, which is housed by the illumination optical system 9 in FIG. 1, is fixed to a center part of the second column 38. In this case, the laser light source 1 in FIG. 1 is installed on the floor FL to the outer side of the pedestal 32 in FIG. 2 in one example, and the illumination light IL that is emitted from the laser light source 1 is guided to the illumination optical system 9 through a beam transmitting optical system (not shown). Furthermore, the reticle stage RST, which holds the reticle R, is mounted on the reticle base 37. In FIG. 2, a column structure CL comprises the first column 36, the reticle base 37, and the second column 38. The column structure CL holds the projection optical system PL, the reticle stage RST, and the illumination optical system 9 in the state wherein it is supported on the upper surface (installation surface) of the pedestal 32 with the plurality of active vibration isolating blocks 35 interposed therebetween.

The set of acceleration sensors 40 discussed above comprises: three Z axis acceleration sensors that measure acceleration in the Z directions at three locations substantially within the XY plane that are not along the same straight line; two X axis acceleration sensors that measure acceleration in the X directions at two locations that are spaced apart in the Y directions; and two Y axis acceleration sensors that measure acceleration in the Y directions at two locations that are spaced apart in the X directions. The set of acceleration sensors 40 measures the acceleration of the column structure CL in the X, Y, and Z directions, as well as its rotational acceleration (rad/s²) around the X, Y, and Z axes. Similarly, the abovementioned set of position sensors (not shown) measures the position of the column structure CL in the X, Y, and Z directions, as well as its rotational angle around the X, Y, and Z axes. Based on these measurement values, the air dampers inside the vibration isolating blocks 35 operate to keep the vibrations of the column structure CL small and maintain the inclination angle and height of the column structure CL in the Z directions so that they are constant.

In addition, the base plate 33, which is on the pedestal 32, supports a wafer base WB in an area that is surrounded by the plurality of the support members 34 and the vibration isolating blocks 35 with three or four active vibration isolating blocks 41 interposed therebetween. The wafer stage WST, which holds the wafer W, is mounted movably on the wafer base WB. The upper surface (installation surface) of the pedestal 32 supports the wafer stage WST, and the vibration isolating blocks 41, each of which comprises an air damper (the same as each of the vibration isolating blocks 35) and the wafer base WB are interposed therebetween. The vibration isolating blocks 41 actively suppress the vibrations of the wafer base WB and the wafer stage WST based on the measurement information of, for example, acceleration sensors and position sensors (not shown) on the wafer base WB.

The vibration isolating blocks 35, 41 of the present embodiment and their control systems (discussed below) constitute the vibration isolating apparatuses. The system that includes the vibration isolating blocks 35, 41 and the control systems can also be called an active vibration isolation system (AVIS). Furthermore, the vibration isolating blocks 35 support the reticle stage RST and the projection optical system PL via the column structure CL, and the scanning speed of the reticle stage RST during scanning exposure is faster than that of the wafer stage WST by severalfold (e.g., fourfold) the inverse of the projection magnification β. Moreover, because the vibration isolating blocks 41 only support the wafer stage WST via the wafer base WB, the column structure CL tends to generate vibrations more than the wafer base WB does. Accordingly, it is also possible to set the vibration isolating performance of the vibration isolating blocks 35 so that it is better than that of the vibration isolating blocks 41.

As discussed above, the active vibration isolating blocks 35, 41 in FIG. 2 can be configured substantially the same. The following explains the configuration and the operation of a typical vibration isolating block 35 and its control system. In addition, although the following explains a mechanism that suppresses vibrations in the Z directions, which are the directions that are parallel to the optical axis AX of the projection optical system PL, the present invention can be similarly adapted to a mechanism that suppresses vibrations in the X and Y directions, as well as to a mechanism that suppresses vibrations in the rotational directions around the X, Y, and Z axes.

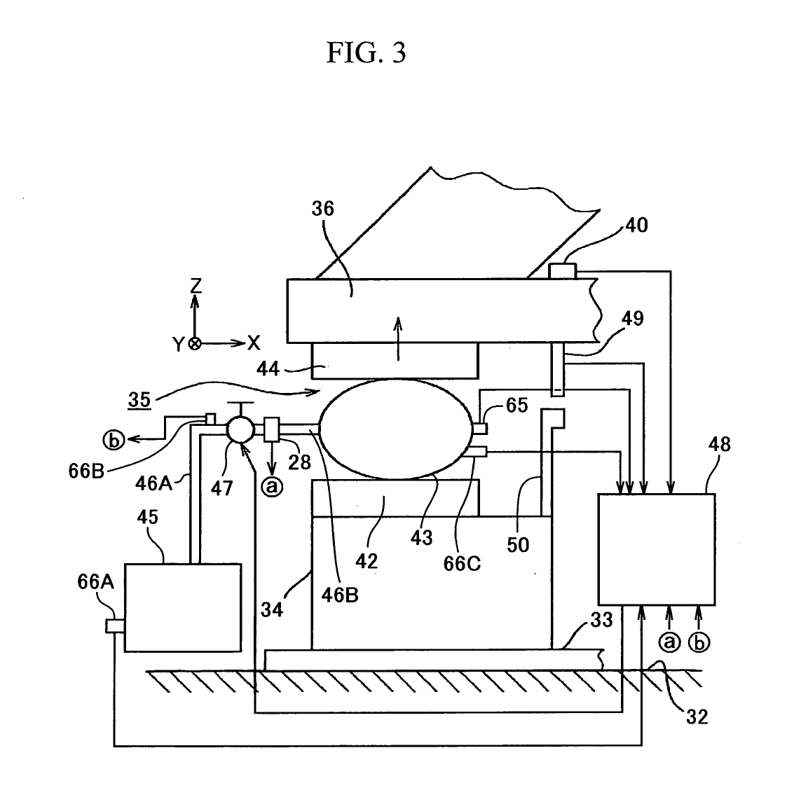

FIG. 3 shows the vibration isolating block 35 of one location in FIG. 2 and its control system; in FIG. 3, the support member 34 is installed on the base plate 33, which is on the pedestal 32, and the first column 36 is mounted on the support member 34 with a bottom plate 42, an air damper 43, and an upper plate 44 interposed therebetween. The air damper 43 comprises a flexible, hollow bag that is filled with air, which serves as a gas, in the state wherein the pressure of the air is controllable. Namely, an input part of a servo valve 47, which controls the rate at which the air flows through a flexible piping 46A, is coupled to a compressed air source 45, which is an end part of a service piping that is coupled to a compressor (not shown) or the like, and an output part of the servo valve 47 is coupled to the air damper 43 via a flexible piping 46B. A flow rate sensor 28, which measures the flow rate of the interior air, is attached midway along the piping 46B. The measurement values of the flow rate sensor 28 are supplied to a vibration isolating block control system 48. The vibration isolating block control system 48 controls the flow rate of the servo valve 47 based on, for example, the measurement values of the flow rate sensor 28.

An example of a sensor that can be used as the flow rate sensor 28 is a thermal, mass flow sensor chip, wherein an upstream side heater and a downstream side heater are formed on a fine diaphragm that is formed on, for example, a silicon substrate, and the flow rate of the gas is derived based on the difference between the temperature distribution on the upstream side and the temperature distribution on the downstream side of the silicon substrate. Such a mass flow sensor chip is compact and is capable of faster response speed than a diaphragm pressure sensor. Furthermore, if the flow rate of the air is high, then it is also possible to use a flow rate sensor of a type that measures, for example, the rotational speed of an impeller as the flow rate sensor 28.

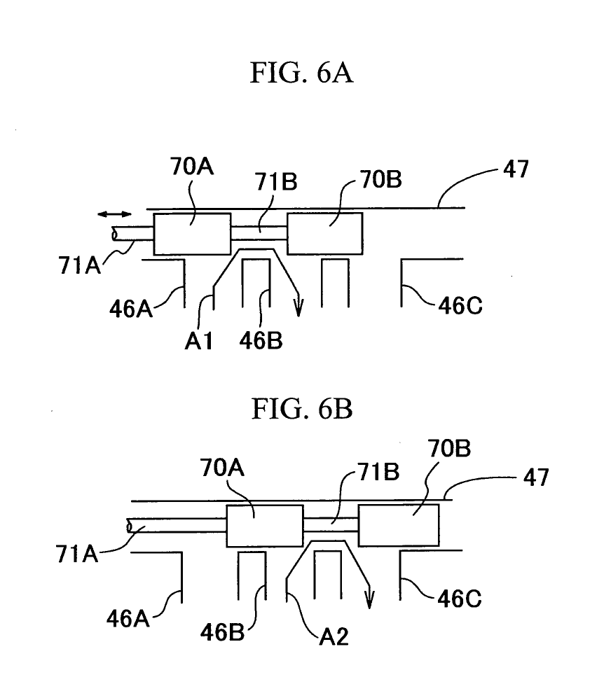

The servo valve 47 of the present embodiment is a spool valve type, as shown in FIG. 6A, wherein two columnar spools 70A, 70B, which are coupled by a rod 71B, are disposed inside the cylindrically shaped main body part of the servo valve 47, and an actuator (not shown) slides these spools 70A, 70B left and right via a rod 71A. In addition, the input part, which communicates with the piping 46A in FIG. 3, the output part, which communicates with the piping 46B in FIG. 3, and an exhaust part, which communicates with a piping 46C that is open to the atmosphere, are formed in the main body part, and sliding the spools 70A, 70B left and right inside the main body part can bring the pipings 46A, 46B or the pipings 46B, 46C into communication with a desired ratio.

As shown in FIG. 6A, moving the spools 70A, 70B to the left side and bringing the pipings 46A, 46B into communication supplies the air in the compressed air source 45 of FIG. 3 to the air damper 43 via the pipings 46A, 46B at a flow rate that is set by the vibration isolating block control system 48, thereby raising the internal pressure in the air damper 43. Meanwhile, as shown in FIG. 6B, moving the spools 70A, 70B to the right side and bringing the pipings 46B, 46C into communication exhausts the air inside the air damper 43 of FIG. 3 to the atmosphere via the pipings 46B, 46C at a flow rate that is set by the vibration isolating block control system 48, thereby lowering the pressure inside the air damper 43. Thus, compared with the case wherein, for example, a nozzle flapper type servo valve is used, using the spool valve type servo valve 47 makes it possible to control the flow rate of the air with higher precision and faster response speed-without wasting the air.

In FIG. 3, a temperature sensor 66A, which measures the temperature of the air inside the service piping (not shown), is installed in the compressed air source 45, and a temperature sensor 66B, which measures the temperature of the air that is supplied to the servo valve 47, is installed in the piping 46A. In addition, a pressure sensor 65, which measures the internal pressure of the air damper 43, and a temperature sensor 66C, which measures the temperature of the interior air, are provided to a side surface of the air damper 43, and the measurement values of the pressure sensor 65 and the temperature sensors 66A-66C are supplied to the vibration isolating block control system 48. Examples of sensors that can be used as the pressure sensor 65 include a sensor wherein a strain gage is fixed to the diaphragm, and a sensor that takes advantage of the deformation of the silicon substrate; in addition, examples of sensors that can be used as the temperature sensors 66A-66C include a thermocouple and a resistive element for temperature measurement (e.g., a thermistor).

Furthermore, in one example of the present embodiment, an operator uses the measurement values of the pressure sensor 65 and the temperature sensors 66A-66C to monitor the air pressure in the air damper 43 and the air temperature at different positions along the air passageway.

However, the usage is not only for merely monitoring. By use of the outputs from the pressure sensor and/or the temperature sensor, the flow rate of the gas supplied to the gas damper can be controlled.

In addition, in FIG. 3, the acceleration sensor 40 and a position sensor 49 are fixed to the first column 36; in the example of FIG. 3, the acceleration sensor 40 measures the acceleration of the first column 36 in the Z directions, and the position sensor 49 measures the relative position and the relative displacement of the first column 36 in the Z directions using a member 50 (or the surface of the floor) that is fixed to the support member 34 as a reference. In one example, the acceleration sensor 40 is a piezoelectric acceleration sensor and the position sensor 49 is an eddy current displacement sensor. Furthermore, a speed sensor may be used as the sensor that detects the acceleration. In this case, the first derivative of the speed detected by the speed sensor may be calculated and used as the acceleration information.

The acceleration sensor 40 in FIG. 3 is represented by a single sensor that measures the acceleration of the first column 36 at the position at which the air damper 43 is installed. The measurement values of the acceleration sensor 40 and the position sensor 49 (the signals that correspond to the acceleration and the position) are supplied to the vibration isolating block control system 48. The vibration isolating block control system 48 controls the flow rate of the air that passes through the interior of the servo valve 47 based on the measurement values of the acceleration sensor 40, the position sensor 49, and the flow rate sensor 28, thereby controlling the internal pressure of the air damper 43 so that the position of the first column 36 in the Z directions is a target position that is prescribed in advance. The sampling rate of the acceleration sensor 40, the position sensor 49, and the flow rate sensor 28 is set so that it is severalfold greater than the upper limit of the response frequency with respect to the internal pressure of the air damper 43 (in the present embodiment, approximately several tens of Hertz).

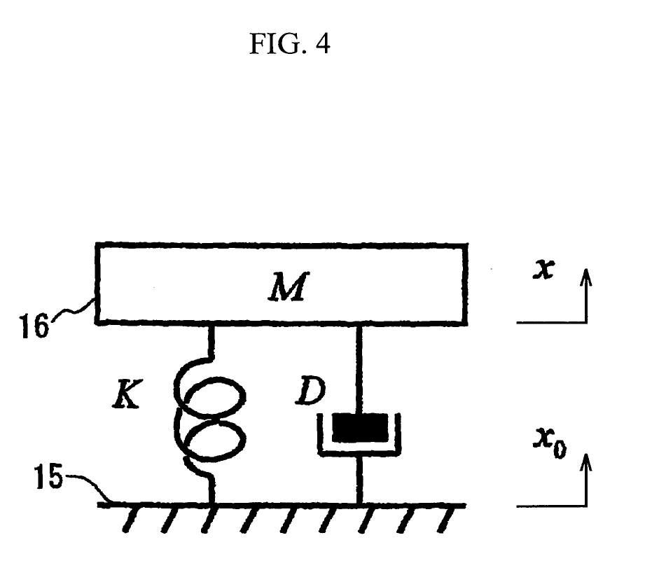

The following explains the control system that controls the internal pressure of the air damper 43 inside the vibration isolating block control system 48 of FIG. 3. FIG. 4 is a dynamic model of the air damper 43 inside the vibration isolating block 35 of FIG. 3; in FIG. 4, an installation surface 15 corresponds to the front surface of the pedestal 32 in FIG. 3, and a structure 16 corresponds to the first column 36 in FIG. 3. More precisely, the structure 16 includes the first column 36 as well as the reticle base 37, the reticle stage RST, the second column 38, the illumination optical subchamber 39, the illumination optical system 9, and the projection optical system PL in FIG. 2. Furthermore, M is the mass of the portion of the structure 16 that is supported by the air damper 43, D is the viscosity proportionality coefficient of the air damper 43, and K is the spring constant. At this point, we can regard the mass M as a coefficient of resistance force (inertia) that corresponds to the acceleration of the structure 16, the viscosity proportionality coefficient D as a coefficient of resistance force that corresponds to the speed of the structure 16, and the spring constant K as a coefficient of resistance force that corresponds to the position of the structure 16.

If A₀ is the effective pressure receiving area of the air damper 43 in FIG. 3, V₀ is the volume, H (V₀/A₀) is the height, p is the internal pressure, and y is the polytropic index, then the spring constant K can be simplified and represented as below.

K=(γ·A₀·p)/H=(γ·A₀²·p)/V₀ (1)

In addition, with the vibration isolating apparatus that uses an air damper, it is possible to lower the natural frequency of the system and thereby improve its performance by reducing the spring constant K (the rigidity) of the air damper. Based on equation (1), the spring constant K is proportional to the inverse of the volume V₀ of the air damper 43; consequently, the more the volume V₀ of the air damper 43 increases (which is constrained by the installation space of the vibration isolating block 35), the more the vibration isolation performance improves. In the present embodiment, using the servo valve 47 with fast response speed to control the internal pressure of the air damper 43 makes it possible to obtain an effect that is the same as that of an air damper 43 that has a larger volume.

In FIG. 4, if xo is the position of the installation surface 15 in the Z directions and x is the position of the structure 16 in the Z directions, then, in the present embodiment, the vibration isolating block 35 in FIG. 3 is controlled so that the relative position of the structure 16 with respect to the installation surface 15 (x-x₀) in one example is a prescribed target position xp. In addition, the position sensor 49 in FIG. 3 measures the relative position (x-x₀), which serves as the positional information of the structure 16 (the first column 36).

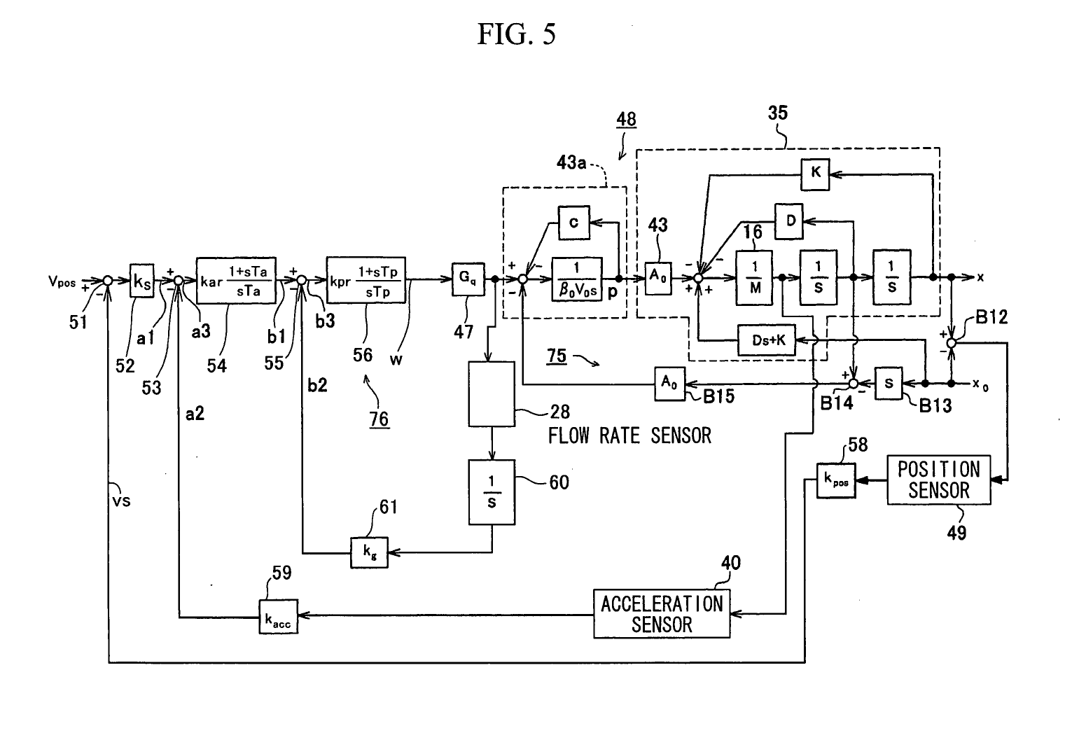

FIG. 5 shows the configuration of the vibration isolating block control system 48, which controls the internal pressure of the air damper 43 in FIG. 3; in FIG. 5, the vibration isolating block 35 is shown by a block diagram as an equivalent circuit of the dynamic model in FIG. 4, and a virtual flow rate/pressure conversion apparatus 43a that determines the internal pressure of the air damper 43 is shown by a block diagram that represents its functions. In addition, the variable s is a variable of a Laplace transform, and if f(Hz) is the frequency, then s=i2πf in the steady state. Furthermore, the vibration isolating block control system 48 basically can be configured by any one of computer software, a digital circuit, and an analog circuit.

In FIG. 5, the flow rate/pressure conversion apparatus 43a sets the internal pressure of the air damper 43 inside the vibration isolating block 35 in accordance with the flow rate that is controlled by the servo valve 47, which has a flow rate gain of G_{q} (m³/(s·V)). The control apparatus 76, which basically includes an amplifier 52, an acceleration PI compensator 54, and a flow rate PI compensator 56, generates an input signal w (voltage V) that is supplied to the servo valve 47. In addition, the control apparatus 76 further comprises a position feedback part, which feeds back the detection results of the position sensor 49, an acceleration feedback part, which feeds back the detection results of the acceleration sensor 40, and a flow rate feedback part, which feeds back the detection results of the flow rate sensor 28.

In this case, a block B12 on the input side of the position sensor 49 represents a virtual calculation that derives the abovementioned relative position (x-x₀; i.e., Δx) by subtracting the position x₀ of the installation surface in the Z directions from the position x of the structure 16 in the Z directions. In the case wherein the position sensor 49 is an eddy current displacement sensor, the signal that corresponds to the relative position Δx, which is measured by the position sensor 49, is fed back as a voltage signal vs to a subtracter 51 via an amplifier 58 with a gain kₚₒₛ(V/m). The position feedback part comprises the amplifier 58 and the subtracter 51.

Furthermore, a target position setting part (not shown) supplies a signal vₚₒₛ (normally a constant voltage V), which corresponds to the target position xₚ of the structure 16 in the Z directions, that is input to the subtracter 51, and the subtracter 51 supplies the difference in voltage (vₚₒₛ−vs) to the subtracter 53 as a signal a1 (the target value of the acceleration of the structure 16) via the amplifier 52 with a gain kₛ.

In addition, the signal that corresponds to the acceleration of the structure 16 that 25 is measured by the acceleration sensor 40 is fed back to the subtracter 53 as a signal a2 via an amplifier 59 with a gain k_{acc} (V/(m/s²)). The acceleration feedback part comprises the amplifier 59 and the subtracter 53.

Furthermore, the subtracter 53 supplies the difference between the two signals (a1−a2) to the acceleration PI compensator 54 as a signal a3 that corresponds to the control error of the acceleration of the structure 16. The acceleration PI compensator 54 supplies a signal b1 to a subtracter 55; here, the signal b1 is obtained by applying a transfer function kₐᵣ(1+sTₐ)/(sTₐ), which uses the gain kₐᵣ and the time constant Ta (s), to the input signal a3.

In addition, the flow rate sensor 28 measures the flow rate of the air that the servo valve 47 supplies to the air damper 43, and a signal that represents the internal pressure (Pa) of the air damper 43, which is obtained by integrating that measurement signal using an integrator (or a pseudo-integrator) 60, is fed back as a signal b2 to the subtracter 55 via an amplifier 61 with a gain k_{g} (V/Pa). The flow rate feedback part comprises the integrator 60, the amplifier 61, and the subtracter 55.

The following is a simple explanation of how the integral of the measurement values of the flow rate sensor 28 represents the internal pressure of the air damper 43. If V₀ is the capacity of the air damper 43, T is the absolute temperature of the interior air, m (mol) is the mass of the interior air, p is the internal pressure, and R is a gas constant, then the following equation holds based on the equation of state of the gas (pV₀=mRT).

m={V₀/(RT)}p (2)

If the capacity V₀ is considered to be substantially constant, and the rate of change of the absolute temperature T is smaller than that of the internal pressure p, then the following equation substantially holds if we differentiate both sides of equation (2) by time t.

dm/dt={V₀/(RT)}(dp/dt) (3)

In equation (3), dm/dt represents the flow rate (mol/s) of the air to the air damper 43, and consequently it can be seen that the flow rate (dm/dt) measured by the flow rate sensor 28 in FIG. 3 (FIG. 5) is the derivative of the internal pressure p of the air damper 43. Accordingly, the internal pressure p of the air damper 43 can be calculated by integrating that flow rate.

At this time, measuring the flow rate of the air to the air damper 43 using the flow rate sensor 28 in the supply step, and then electrically integrating the measurement values makes it possible to monitor the internal pressure of the air damper 43 with faster response speed than the case wherein the internal pressure of the air damper 43 is actually measured with a pressure sensor. Furthermore, a diaphragm type pressure sensor or the like has coarse resolving power and slower response speed than a flow rate sensor does, and the internal pressure of the air damper 43 can be controlled with higher precision and faster response speed by using the measurement values of the flow rate sensor 28.

In FIG. 5, the subtracter 55 supplies the differential of two signals (b1−b2) to the flow rate PI compensator 56 as a signal b3 that corresponds to the control error of the internal pressure of the air damper 43. The flow rate PI compensator 56 supplies the signal w (the signal, which is a voltage or the like, that is used to control the flow rate) to the servo valve 47 with a flow rate gain Gq; here, the signal w is obtained by applying a transfer function kₚᵣ(1+sTₚ)/(sTₚ), which uses the gain kₚᵣ and the time constant Tₚ(s), to the input signal b3. As a result, the flow rate of the air that the servo valve 47 supplies to the air damper 43 is set to w·G_{q}.

In addition, in FIG. 5, a virtual flow rate feedback apparatus 75 is formed by the mechanism that comprises the servo valve 47 and the vibration isolating block 35. The flow rate feedback apparatus 75 comprises: a block B14 that subtracts a speed obtained by virtually integrating the acceleration of the structure 16 from a speed obtained by differentiating the position of the installation surface via a block B13; a block B15 that multiplies the output of the block B14 by the effective pressure receiving area A₀ of the air damper 43; and a virtual adding and subtracting part inside the flow rate/pressure conversion apparatus 43a. Namely, the output of the block B15 corresponds to the rate of increase in the volume of the air damper 43, and consequently the pressure of the air damper 43 is determined based on the flow rate that is obtained by subtracting the rate of increase in the volume of the air damper 43 from the flow rate of the servo valve 47.

Furthermore, in FIG. 5, if β₀(1/Pa) is the compression ratio of the air damper 43 (the flow rate/pressure conversion apparatus 43a), V₀(m³) is the capacity, and c ((m³/s)/Pa) is the flow rate conductance, then in one example the time constant Tp of the flow rate PI compensator 56 is set so that it is β₀V₀/c, and the time constant Ta of the acceleration PI compensator 54 is set to, for example, Tₚ/(G_{q}kₚᵣk_{g}). As a result, the internal pressure p of the air damper 43 inside the vibration isolating block 35 is controlled so that it is a target value (the value that corresponds to the signal b1 that is output from the acceleration PI compensator 54). Thereby, the acceleration of the structure 16 is controlled so that it is the target value (the value that corresponds to the signal a1 that is output from the amplifier 52), and ultimately the signal vs that corresponds to the relative position Δx of the structure 16 is controlled so that it equals the signal vₚₒₛ, which corresponds to the target position xp; thereby, vibration isolation is performed.

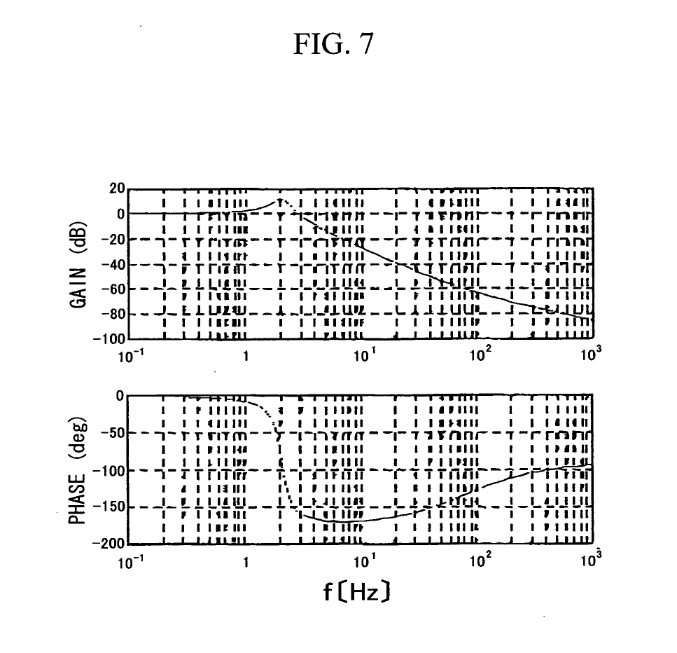

FIG. 7 shows one example of the vibrations of the first column 36 (the structure 16), which is supported by the vibration isolating block 35 in FIG. 3; in FIG. 7, the abscissa represents the frequency f (Hz), and the upper part ordinate represents the gain (dB) while the lower part ordinate represents the phase (deg). The characteristics in FIG. 7 were calculated by analyzing the frequency of the fluctuations in the relative position Δx for the case wherein prescribed impulse vibrations were applied to the first column 36 in FIG. 3 in the vibration isolating block control system 48 of FIG. 5—without feedback of the flow rate measured by the flow rate sensor 28. In this case, vibration isolation was performed with fast response speed and was equivalent to that of an air damper 43 with a larger volume by feeding back the flow rate measured by the flow rate sensor 28 (e.g., determining the value of the gain kg) so as to suppress the peak that appears in the upper part of FIG. 7 because of the natural vibration.

The operational advantages of the vibration isolating apparatus of the present embodiment are described below.

(1) As shown in FIG. 3 and FIG. 5, in the embodiment, the vibration isolating apparatus includes: the compressed air source 45, which supplies the air; the air damper 43, into which the air is supplied, that supports the first column 36 (the structure 16) on the base plate 33; the servo valve 47, which controls the flow rate of the air that is supplied from the compressed air source 45 to the air damper 43; the position sensor 49 and the acceleration sensor 40 that measure the position and acceleration provided to the first column 36 by the air damper 43; and the vibration isolating block control system 48 that controls the flow rate of the air at the servo valve 47 based on the measured position and acceleration.

In this case, the internal pressure of the air damper 43 is obtained by integrating the flow rate, and that flow rate information is one of the state quantities that relate to the thrust that is applied from the air damper 43 to the first column 36.

With the vibration isolating apparatus of the present embodiment, the internal pressure of the air damper 43 is controlled by controlling the flow rate of the air at the servo valve 47 based on the measurement values of the flow rate sensor 28, and thereby active vibration isolation is performed. According to the equation of state of the air inside the air damper 43, the integral of the flow rate of the air is substantially the internal pressure, and consequently controlling the flow rate of the air that flows into the air damper 43 (e.g., performing control based on the measurement values of the internal pressure of the air damper 43 so that the internal pressure reaches the prescribed target value) makes it possible to control the internal pressure of the air damper 43 with higher precision and faster response speed (reduced overshoot and undershoot of the internal pressure) compared with the case wherein the air is fed to the air damper 43 at a fixed flow rate, and, in turn, to perform active vibration isolation for the first column 36 (the exposure apparatus).

(2) Furthermore, in the control method in the embodiment, the flow rate sensor 28 measures the flow rate at the servo valve 47 at the previous stage before the supply for the air damper 43, the integrator 60 integrates the measurement value of the flow rate so as to obtain the internal pressure information of the air damper 43.

In other words, the vibration isolating block control system 48 of FIG. 5 comprises: the integrator 60 and the amplifier 61, which obtain the signal b2 by integrating the measurement values of the flow rate sensor 28 and multiplying it by the gain kg; and the subtracter 55, which subtracts the signal b2 from the signal b1 (a first drive quantity) to derive the signal b3 (a second drive quantity); in addition, the vibration isolating block control system 48 controls the flow rate of the servo valve 47 based on the signal b3. With this configuration, the internal pressure of the air damper 43 is derived by integrating that flow rate, which makes it possible to control the internal pressure of the air damper 43 so that it equals the value that corresponds to the signal b1 with faster response speed. Furthermore, it is also possible to omit the integrator 60.

(3) In addition, the vibration isolating apparatus in FIG. 3 and FIG. 5 comprises the position sensor 49, which measures the position of the first column 36 (the structure 16); in addition, the vibration isolating block control system 48 comprises a portion (position feedback part) that includes the subtracter 51 that derives the abovementioned signal b1 by subtracting the signal vs, which corresponds to the measurement value of the position sensor 49, from the signal vₚₒₛ, which corresponds to the target position of the first column 36. Accordingly, controlling the internal pressure of the air damper 43 makes it possible to control the position of the first column 36 so that it is at the target position.

In addition, the control apparatus 76 in FIG. 5 includes the position feedback part and the acceleration feedback part (the amplifier 59 and the subtracter 53) that uses the measurement values of the acceleration sensor 40, and it is therefore possible to control the position of the first column 36 with higher precision and faster tracking speed so that it is at the target position.

Furthermore, in the case wherein, for example, control is performed so that the internal pressure of the air damper 43 is the prescribed fixed target value, it is also possible to omit the position feedback part and the acceleration feedback part.

(4) In addition, because the servo valve 47 is a spool valve type, it is also possible to control the flow rate with high precision and fast response speed.

Furthermore, in the case wherein it is acceptable for the utilization factor of the air to fall, it is also possible to use, for example, a nozzle flapper type servo valve as the servo valve 47.

(5) In addition, the vibration isolating apparatus in FIG. 3 comprises the pressure sensor 65, which monitors the internal pressure of the air damper 43, and consequently the operator can monitor the internal pressure thereof. Furthermore, it is also possible to omit the pressure sensor 65.

(6) In addition, the exposure apparatus of the present embodiment is an exposure apparatus that illuminates the pattern of the reticle R with the illumination light (exposure light) IL and exposes the wafer W with the illumination light IL through that pattern and the projection optical system PL, and comprises the vibration isolating apparatus of the present embodiment in order to support the first column 36 and the wafer base WB (prescribed members), which constitute the exposure apparatus, on the pedestal 32 and the base plate 33 (base members).

According to this exposure apparatus, the vibration isolation performance of the vibration isolating apparatus is improved, and it is therefore possible to transfer the pattern onto the wafer W with high exposure accuracy (positioning accuracy and overlay accuracy). Furthermore, the present invention can also be adapted to the case wherein vibration isolation is performed for, for example, a proximity type exposure apparatus that does not have a projection optical system.

(7) In addition, the device fabricating method of the present embodiment includes a process wherein the pattern of a device is transferred onto the wafer using the exposure apparatus of the present embodiment. With this device fabricating method, the vibration isolating performance of the exposure apparatus is improved, and therefore it is possible to fabricate devices with high precision and high yield.

### Second Embodiment

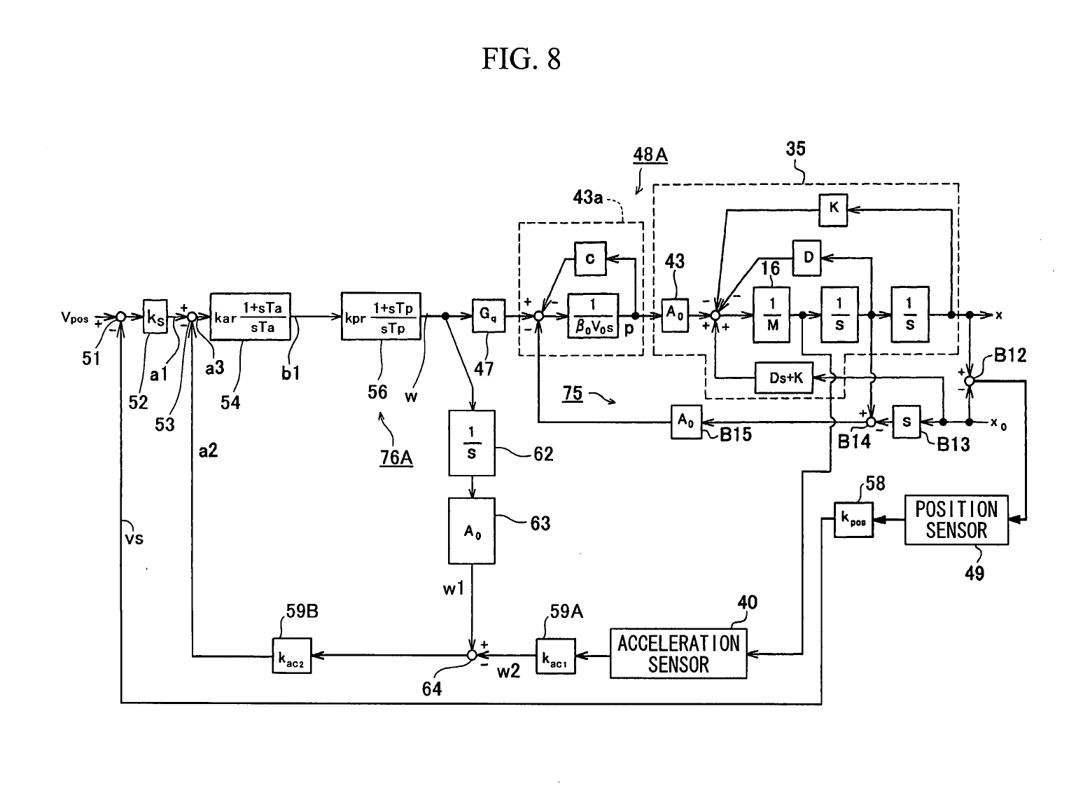

Next, a second embodiment of the present invention will be explained, referencing FIG. 8. The present embodiment as well basically uses the vibration isolating block 35 in FIG. 3 in the exposure apparatus of FIG. 1 and FIG. 2, but is different in that it only uses the measurement values of the acceleration sensor 40 and the position sensor 49 to control the flow rate of the servo valve 47 in FIG. 3, and does not use the flow rate sensor 28. Below, portions in FIG. 8 that correspond to those in FIG. 5 are assigned the same symbols, and detailed explanations thereof are omitted.

FIG. 8 shows the configuration of the vibration isolating block control system 48A of the present embodiment, which controls the operation of the vibration isolating block 35 in FIG. 3; in FIG. 8, a control apparatus 76A, which basically includes the amplifier 52, the acceleration PI compensator 54, and the flow rate PI compensator 56, generates the signal w that controls the flow rate of the servo valve 47. In addition, the control apparatus 76A further comprises a position and acceleration feedback part that feeds back the detection results of the position sensor 49 and the acceleration sensor 40.

In this case, the relative position Δx(x−x₀) of the structure 16 (corresponds to the first column 36 in FIG. 3), which is measured by the position sensor 49, is supplied to the subtracter 53 as the signal a1 (the target value of the acceleration of the structure 16), which corresponds to the difference from the target position xₚ, via the amplifier 58 and the subtracter 51. In addition, the signal that corresponds to the acceleration of the structure 16, which is measured by the acceleration sensor 40, is supplied to a subtracter 64 as a signal w2 via an amplifier 59A with a gain k_{ac1} (equal to the mass M of the structure 16). Furthermore, the signal w that is supplied from the flow rate PI compensator 56 to the servo valve 47 is supplied to the subtracter 64 as a signal w1 via an integrator (or a pseudo-integrator) 62 and an amplifier 63, which multiplies its input by the effective pressure receiving area A₀ of the air damper 43. The subtracter 64 supplies the differential signal (w1−w2), which is obtained by subtracting the signal w2 from the signal w1, to an amplifier 59B with a gain k_{ac2}, and the signal a2, which is output from the amplifier 59B, is fed back to the subtracter 53.

Furthermore, the subtracter 53 supplies the differential between the two signals (a1−a2) to the acceleration PI compensator 54 as the signal a3, which corresponds to the control error of the acceleration of the structure 16, and the signal b1, which is output from the acceleration PI compensator 54, is supplied to the servo valve 47 and the integrator 62 as the signal w via the flow rate PI compensator 56. The position and acceleration feedback part comprises the integrator 62, the amplifiers 58, 59A, 59B, and the subtracters 64, 51, 53. The configuration is otherwise similar to that of the first embodiment (FIG. 5).

In the vibration isolating block control system 48A of FIG. 8, the signal w1 obtained by passing the signal w, which is output from the flow rate PI compensator 56, through the integrator 62 and the amplifier 63 corresponds substantially to the thrust that is imparted from the air damper 43 to the structure 16. In addition, the signal w2 obtained from the acceleration sensor 40 and the amplifier 59A corresponds to the thrust that actually acts on the structure 16. Accordingly, the signal a2, which is output to the subtracter 53 from the subtracter 64 and the amplifier 59B, corresponds to the acceleration of the structure 16 that is caused by disturbances such as vibrations from the floor and vibrations generated by the stages of the exposure apparatus. In the present embodiment, the internal pressure of the air damper 43 is controlled by controlling the flow rate at the servo valve 47 so that the acceleration of the structure 16 that is caused by such disturbances is a target value that corresponds to the signal a1, and active vibration isolation is thereby performed.

In addition to the operational advantages of the first embodiment, the present embodiment has the following operational advantages.

As shown in FIG. 8, the vibration isolating apparatus of the present embodiment comprises: the position sensor 49 that functions as a sensor that measures the state quantity related to the thrust imparted to the structure 16 (the first column 36 in FIG. 3) from the air damper 43, and thereby measures the position of the structure 16; and the acceleration sensor 40 that measures the acceleration of the structure 16. Furthermore, the control apparatus 76A controls the flow rate at the servo valve 47 by feeding back the difference between the signal w1, which is obtained by integrating the signal that is supplied to the servo valve 47, and the signal w2, which is obtained from the acceleration sensor 40, as well as the signal vs, which is obtained from the position sensor 49.

In this case, the response speed of the position sensor 49 and the response speed of the acceleration sensor 40 are much faster than, for example, a diaphragm type pressure sensor, and the measurement accuracy of the acceleration sensor 40 is much higher than the accuracy of the acceleration that is calculated based on the measurement values of the pressure sensor. According to the present embodiment, it is possible to control the internal pressure of the air damper 43 with high precision and fast response speed, and therefore higher vibration isolation performance is obtained compared with the case wherein a pressure sensor monitors the internal pressure of the air damper 43 and the flow rate of the servo valve 47 is controlled based on the result thereof.

Furthermore, in the present embodiment, the position sensor 49 and the acceleration sensor 40 may be omitted. In one example, if the position sensor 49 is omitted, then the position of the structure 16 may be derived by double integrating the output of the acceleration sensor 40. In addition, if the acceleration sensor 40 is omitted, then the acceleration of the structure 16 may be derived by calculating the second derivative of the position sensor 49. In addition, in the case wherein, for example, it is acceptable to control just the internal pressure of the air damper 43 so that it is a prescribed target value, then it is also possible to omit the position feedback part that uses the position sensor 49.

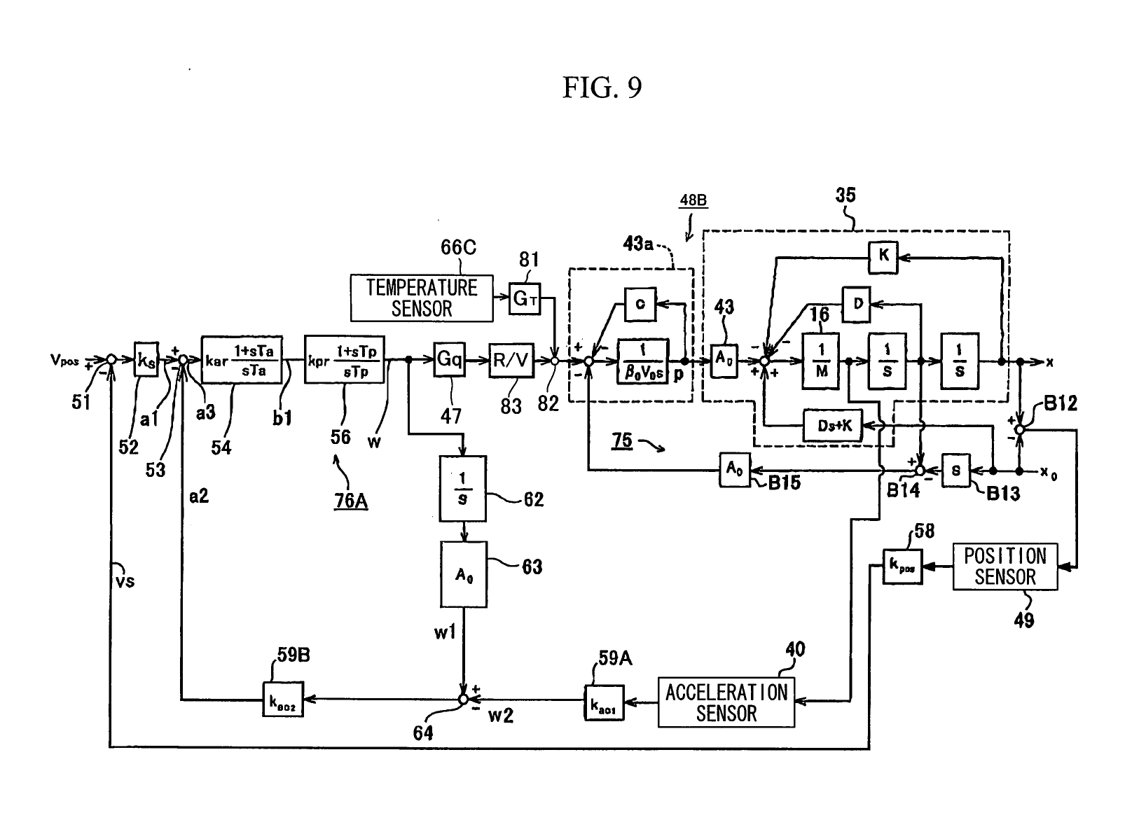

In the abovementioned embodiments, the temperature information of the air damper 43 is not utilized. However, for example, in the vibration isolating block control system 48B shown in FIG. 9, the measurement value of the temperature sensor 66C (refer to FIG. 3), which measures the temperature of the interior air of the air damper 43, can be fed back. That is, in FIG. 9 (where the same reference symbols are appended to the parts corresponding to that in FIG. 8), the output (i.e., command signal of flow rate) of the servo valve 47 is provided to a multiplier 82 via a converter 83, which converts the flow rate signal into the pressure change signal, and the measurement signal of the temperature sensor 66C is provided to the multiplier 82 via an amplifier 81 of gain KT. And then the air damper 43 is driven by the signal, which is obtained by multiplying the outputs of the converter 83 and the amplifier 81 at the multiplier 82. In this case, the virtual flow rate/pressure conversion apparatus 43a can function as low-pass filter having cutoff frequency fc of about 1 Hz. The other parts have same components as that shown in FIG. 8.

In this case, when the V₀ (the capacity of the air damper 43) is replaced with V in equation (2), the equation of state of the gas is follows:

pV=mRT (11)

The internal pressure p of the air damper 43 can be obtained in the following equation:

p=mRT/V (12)

The following equation substantially holds if we differentiate equation (12) by time t,

dp/dt=(dm/dt)(RT/V) (13)

This relationship can correspond to the constitution of FIG. 9. Therefore, in the modified example shown in FIG. 9, by feeding back the temperature information of the air damper 43, the vibration isolation can be performed with high precision. Alternately, the temperature sensor 66C can be replaced with the other sensors 66A, 66B or the like.

In the description of the embodiments, examples of the state quantity related to the trust provided from the air damper to the structure comprises the position of the structure, the acceleration of the structure, the flow information at the air damper, and the air temperature in the air damper, but are not restricted thereto. Alternatively or also, the velocity of the structure and/or the pressure of the air damper can be utilized.

Furthermore, in the abovementioned embodiments, air is used as the gas for the gas damper, but nitrogen gas, a noble gas (helium, neon, etc.), or a gas mixture may be used instead.

Furthermore, the present invention can also be adapted to the case wherein active vibration isolation is performed in a liquid immersion type exposure apparatus, as disclosed in, for example, PCT International Publication WO 99/49504. In addition, the present invention can also be adapted to the case wherein vibration isolation is performed in, for example, a projection exposure apparatus that uses extreme ultraviolet light (EUV light) with a wavelength of approximately one to several hundred nanometers as the exposure beam, or an exposure apparatus of a proximity type or a contact type that does not use a projection optical system.

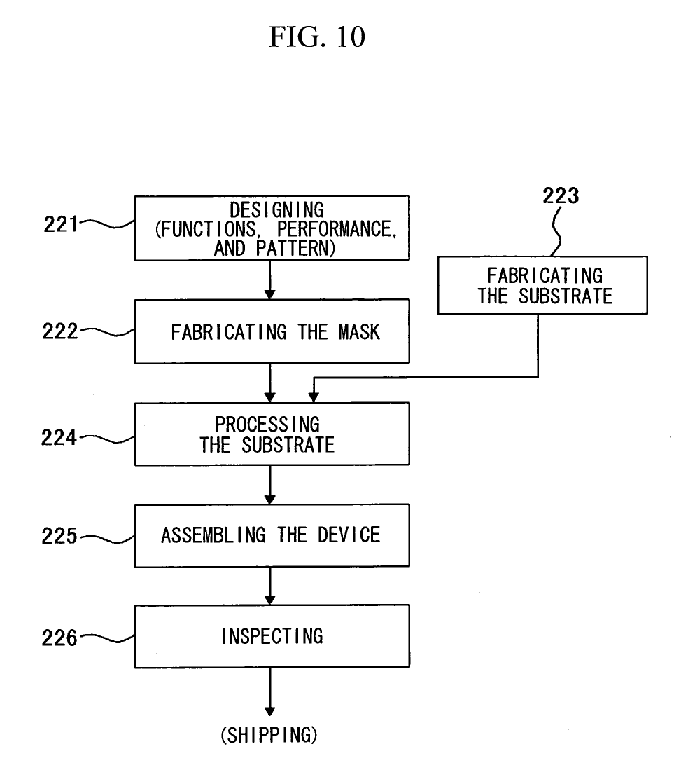

When the exposure apparatus according to the abovementioned embodiments is used to fabricate a microdevices such as semiconductor devices, as shown in FIG. 10, the microdevices are manufactured by going through: a step 221 that performs microdevice function and performance design; a step 222 that creates the mask (reticle) based on this design step; a step 223 that manufactures the substrate that is the device base material; a step 224 including substrate processing steps such as a process that exposes the pattern on the mask onto a substrate by means of the exposure apparatus of the aforementioned embodiments, a process for developing the exposed substrate, and a process for heating (curing) and etching the developed substrate; a device assembly step 225 (including treatment processes such as a dicing process, a bonding process and a packaging process); and an inspection step 226, and so on. Since the exposure apparatus in the present embodiments has high performance of vibration isolation, the device can be fabricated with high precision.

In addition, the present invention is not limited in its application to processes of fabricating semiconductor devices; for example, the present invention can be adapted widely to processes for fabricating display apparatuses, such as plasma displays or liquid crystal display devices that are formed in an angular glass plate, as well as to processes for fabricating various devices such as image capturing devices (CCDs and the like), micromachines, microelectromechanical systems (MEMS), thin film magnetic heads wherein a ceramic wafer is used as a substrate, and DNA chips. Furthermore, the present invention can also be adapted to fabrication processes that are employed when photolithography is used to fabricate masks (photomasks, reticles, and the like) wherein mask patterns of various devices are formed.

In the abovementioned embodiments, the vibration isolating apparatus (e.g., the vibration isolating blocks 35 and control system thereof) and the exposure apparatus are manufactured by assembling various subsystems, including the respective constituent elements presented in the Scope of Patents Claims of the present application, so that the prescribed mechanical precision, electrical precision and optical precision can be maintained. To ensure these respective precisions, performed before and after this assembly are adjustments for achieving optical precision with respect to the various optical systems, adjustments for achieving mechanical precision with respect to the various mechanical systems, and adjustments for achieving electrical precision with respect to the various electrical systems. The process of assembly from the various subsystems to the apparatuses includes mechanical connections, electrical circuit wiring connections, air pressure circuit piping connections, etc. among the various subsystems.

Furthermore, the present invention can also be adapted to a case wherein vibration isolation is performed for equipment other than an exposure apparatus, e.g., a defect inspection apparatus or a coater/developer for photosensitive materials. The above explained embodiments of the present invention based on the drawings, but the specific constitution is not limited to these embodiments, and it is understood that variations and modifications may be effected without departing from the spirit and scope of the invention.

The entire disclosures in Japanese Patent Application No. 2007-144864, filed on May 31, 2007, including the contents of the specification, the scope of patent claims, the drawings, and the summary, are incorporated in this application by reference.

As far as is permitted, the disclosures in all of the Publications and U.S. Patents related to exposure apparatuses and the like cited in the above respective embodiments and modified examples, are incorporated herein by reference.

Note that embodiments of the present invention have been described above, however, the present invention can be used by appropriately combining all of the above described component elements, or, in some cases, a portion of the component elements may not be used.

What is claimed is:

1. A vibration isolating apparatus comprising:
a gas supply source;
a gas damper, the interior of which is supplied with gas form the gas supply source, that supports a structure on an installation surface;
a flow control apparatus in which a flow rate of the gas from the gas supply source toward the gas damper is controlled;
a state quantity sensor that monitors a state quantity related to thrust that is applied to the structure from the gas damper; and
a control apparatus that controls the flow rate apparatus based on the monitoring result of the state quantity sensor.

2. The vibration isolating apparatus according to claim 1, wherein
the state quantity sensor comprises at least one of a position sensor that obtains position information of the structure and an acceleration sensor that obtains acceleration information of the structure.

3 A vibration isolating apparatus according to claim 1, wherein
the control apparatus controls the flow control apparatus so that a second value, which can be obtain based on a first value related to the thrust and on the monitoring result of the state quantity sensor, related to the acceleration of the structure is to be a third value related to the target control quantity of the gas damper.

4. A vibration isolating apparatus according to claim 1, wherein
the state quantity sensor comprises a first state quantity sensor that monitors a first state quantity and a second state quantity sensor that monitors a second state quantity differing from the first state quantity,
the control apparatus controls the flow rate of the gas at the flow control apparatus so that a second value, which can be obtain based on a first value related to the thrust and on the monitoring result of the second state quantity sensor, related to the acceleration of the structure is to be a third value, which can be obtain based on the monitoring result of the first state quantity sensor, related to the target control quantity of the gas damper.

5. A vibration isolating apparatus according to claim 1, further comprising:
a temperature sensor that obtain temperature information of the gas,
wherein
the control apparatus controls the flow control apparatus based on a measurement value from the temperature sensor.

6. A vibration isolating apparatus according to claim 1, wherein
the state quantity sensor comprises a flow rate sensor that obtains flow information of the gas from the flow control apparatus toward the gas damper;
the control apparatus comprises an integrating part, which integrates a measurement value of the flow rate sensor, and a first subtracting part, which derives a second drive quantity of the gas damper by subtracting the output of the integrating part from a first drive quantity, which is obtained based on the monitoring result of the state quantity sensor; and
the flow rate of the flow control apparatus is controlled based on the second drive quantity.

7. A vibration isolating apparatus according to claim 6, further comprising:
a position sensor that obtains position information of the structure;
wherein,
the control apparatus comprises a second subtracting part that derives the first drive quantity by subtracting the measurement value of the position sensor from a target position of the structure.

8. A vibration isolating apparatus according to claim 1, wherein
the flow control apparatus is a spool valve type servo valve.

9. A vibration isolating apparatus according to claim 1, further comprising:
a gas sensor that obtains pressure information of the gas inside the gas damper.

10. An exposure apparatus that comprises a vibration isolating apparatus according to claim 1 in order to support a prescribed member that constitutes the exposure apparatus on a base member.

11. A device fabricating method, wherein
the exposure apparatus according to claim 10 is used.

12. A control method for a vibration isolating apparatus that comprises a gas supply source and a gas damper, the interior of which is supplied with gas form the gas supply source, that supports a structure on an installation surface, the method comprising:
measuring a value related to a derivative component of an internal pressure of the gas damper; and
electrically integrating the value obtained by the measurement to obtain a value of the internal pressure.

13. A control method according to claim 12, wherein the value related to the derivative component is a flow rate of the gas, which is supplied from the gas supply source to the gas damper.
